(19) United States
(12) Patent Application Publication
(10) Pub. No.: US 2017/0022108 A1
(43) Pub. Date: Jan. 26, 2017

(54) CALCIUM SULFATE COMPOSITION COMPRISING AN ADDITIVE

(71) Applicant: BASF SE, Ludwigshafen (DE)

(72) Inventors: Torben GAEDT, Traunstein (DE); Harald GRASSL, Feichten (DE); Martin WINKLBAUER, Halsbach (DE); Oliver MAZANEC, Rosenheim (DE)

(73) Assignee: BASF SE, Ludwigshafen (DE)

(21) Appl. No.: 15/113,190

(22) PCT Filed: Jan. 9, 2015
(86) PCT No.: PCT/EP2015/050282

§ 371 Date: Jul. 21, 2016

(30) Foreign Application Priority Data
Jan. 21, 2014 (EP) 14151976.9

(51) Int. Cl. C04B 24/26; C04B 28/14

(52) U.S. Cl. CPC C04B 24/2647; C04B 28/14; C04B 2103/006

(57) ABSTRACT

The invention relates to a composition comprising at least 10 wt. % of a binder based on calcium sulfate and 0.005 to 5 wt. % of an additive made of at least one water-soluble salt of a multivalent metal cation, at least one compound which is capable of releasing an anion that forms a poorly soluble salt together with the multivalent metal cation, and at least one polymer dispersant which comprises anionic and/or anionogenic groups and polyether side chains. The invention further relates to a method for producing said composition and to the use thereof as a calcium sulfate flow screed, a flowable calcium sulfate filler compound, or an earth-moist calcium sulfate screed.

The invention relates to a composition comprising calcium sulfate and an additive, the additive allowing the fluidity of the composition to be improved in conjunction with long workability, and the composition subsequently achieving rapidly a high strength and more particularly early strength. The compositions of the invention may be used in particular as self-leveling screed.

Self-leveling anhydrite screeds are screeds which are pumped in various mortar consistencies into the construction. These screeds undergo largely autonomous leveling or are leveled with little effort, using for example a dapple bar. Advantages of self-leveling anhydrite screeds include the high tensile flexural strength, low tendency toward curling (upward dishing of the screed bed at the edges as a result of contraction), and the possibility even for large areas to be laid without joints.

In practice such self-leveling screeds are employed in the form of wet and dry mortar systems. Wet mortars are supplied to the building site in a mixed form using mixer vehicles; dry mortars are supplied to the building site in silos or in sacks, and are mixed on site.

A particular binder used here is anhydrite. Within the area of the anhydrites (chem. CaSO₄), natural anhydrite, synthetic anhydrite, and thermal anhydrite (FGD anhydrite) are known. In contrast to gypsum (chem. CaSO₄*½ H₂O), anhydrite does not set within a practical time following addition of water. Setting occurs only after suitable activators have been added. In addition to pure anhydrite, diverse mixtures of this type of binder are used as well, such as anhydrite/calcined gypsum hybrid systems with a calcined gypsum fraction of up to 50 wt %, for example. The calcined gypsum here may have been produced from natural or FGD gypsum; customarily, however, α-hemihydrate is employed. Other binder mixtures based on anhydrite that are used include anhydrite/cement hybrid systems. With these systems, a compromise is entered between the low contraction values of the anhydrite and the water resistance of the cement. The cement fraction is customarily less than ⅓ of the total amount of binder.

In the case of the self-leveling anhydrite screeds, alkaline activators used are preferably cement and/or salt-like activators, such as calcium sulfate, for example.

When α-hemihydrate is used, then generally retarders are added as well, in which case, for example, hydrolyzed proteins or polyhydroxycarboxylic acids (such as tartaric acid, for example) are suitable. Examples of further possible additions are antifoams and stabilizers.

One important group of admixtures is that of the superplasticizers. With these, workability is made easier and in particular the fluidity is improved. For these purposes, in general, various lignosulfonates, naphthalenesulfonates and/or melamine-formaldehyde sulfite condensation products are employed. These classes of compound have become established in the art, but a disadvantage is that they maintain workability only for a relatively short period.

The use of copolymers based on a polycarboxylate ether as superplasticizers and slump retainers for chemical construction materials is likewise well known. Such copolymers consist essentially of an olefinically unsaturated monocarboxylic acid comonomer or an ester or a salt thereof and/or an olefinically unsaturated sulfonic acid comonomer, on the one hand, and of a polyether-functional comonomer on the other. Copolymers of these kinds are described in more detail for example in EP 0 537 870, EP 0 736 553, EP 1 138 698, EP 1 189 955 and EP 1 902 085.

For self-leveling calcium sulfate screeds and filling compounds in particular, the prior art uses superplasticizers and slump retainers based in particular on melamine-formaldehyde condensates, since they cause only minimal retardation of the binder setting reaction, although the open time in this case is relatively short.

Disadvantageous in relation to the polycarboxylate ether-based copolymers as superplasticizers, it has emerged, is the open time, which for many applications is not sufficient.

As already mentioned, the loss of slump flow over time is relatively high with the systems available on the market that use superplasticizers based on melamine-formaldehyde condensates. On the other hand, a long working time, particularly on large building sites or those with geometric complexities (e.g., L-shaped rooms with the door in the angle), is important to allow the screed introduced to level even after a relatively long time period.

In many cases, self-leveling anhydrite screeds are mixed with water at the screed manufacturer's plant itself and are supplied by mixer vehicle to the building site. To allow the screed delivered to develop its self-leveling properties on the building site, open times of 3-4 hours are often necessary for mixer vehicle formulations.

Polymeric superplasticizers coat the surfaces of the binder components and so produce greater fluidity of the particles in the moist composition, thereby permitting savings of considerable quantities of mixing water.

Another effect of reducing the amount of water, however, is that the cured products obtained exhibit increased strength and density. A further advantage of adding copolymers based on polycarboxylate ethers to the preferred and much more favorable □ form of the hemihydrate is to come close to the water/gypsum values of the expensive □ form.

U.S. Pat. No. 7,338,990 B2 describes a mixture which comprises cement and calcined gypsum and, furthermore, a polycarboxylate ether dispersant. The dispersant is a copolymer based on an oxyalkylene glycol alkyl ether and unsaturated dicarboxylic acid derivatives. This mixture is used to produce products for the exterior sector.

From U.S. Pat. No. 7,056,964 B2 likewise a mixture is described which can be processed with a defined amount of mixing water to form a slurry that can be used as a self-leveling screed with high strength. The mixture consists of a calcium sulfate hemihydrate, where at least 25% must be present in the □ form, and of a polycarboxylate superplasticizer. The superplasticizer is a copolymer of an oxyalkylene alkyl ether and an unsaturated dicarboxylic acid.

WO 0249983 describes the use of polycarboxylate ether-based superplasticizers composed of water-soluble copolymers for self-leveling anhydrite-based screeds. The compounds described afford good flow and leveling properties in the binder system and a relatively long workability.

Having been found disadvantageous in relation to the prior art is an insufficiently long open time on the part of the compositions produced.

The building industry is calling for systems which emit few or no volatile organic compounds. This demand is clear, for example, in the Emicode seal of the German Association for the Control of Emissions in Products for Flooring Installation, Adhesives and Building Materials (GEV). This is particularly relevant for the use of building materials in interior rooms, such as self-leveling screeds. A disadvantage of condensates based on melamine sulfonate-formaldehyde condensates is that it is not possible to rule out entirely the escape of volatile organic compounds such as formaldehyde into the air.

It was an object of the present invention, accordingly, to provide superplasticizers for calcium sulfate-based compositions that do not have the stated disadvantages of the prior art but which instead exhibit outstanding plasticizing activity, at the same time maintain the workability of the calcium sulfate-based compositions for a relatively long time, and thereafter rapidly enable high strength and more particularly early strength of the calcium sulfate-based compositions. The superplasticizers ought, furthermore, to emit as little as possible of volatile organic compounds into the air.

This object is achieved by the following embodiments:

1. A composition comprising, based on the total mass of the composition A) at least 10 wt % of a binder based on calcium sulfate and B) 0.005 to 5 wt % of an additive prepared from
i) at least one water-soluble salt of a polyvalent metal cation,
ii) at least one compound able to release an anion which forms a sparingly soluble salt with the polyvalent metal cation, and
iii) at least one polymeric dispersant which comprises anionic and/or anionogenic groups and polyether side chains,
   the polyvalent metal cation being selected from Al³⁺, Fe³⁺, Fe²⁺, Zn²⁺, Mn²⁺, Cu²⁺, Mg²⁺, Ca²⁺, Sr²⁺, Ba²⁺ and mixtures thereof,
   the metal cation being present in an amount such that the following relation according to formula (a) is greater than 0.1 and less than or equal to 30:

$$0.1 < \frac{{Σ}_{i} {z}_{K , i} {n}_{K , i}}{{Σ}_{j} {z}_{s , j} {n}_{s , j}} \leq 30 \qquad ( a )$$

and where
z_{K,i} is the amount of the charge number of the polyvalent metal cation,
n_{K,i} is the number of moles of the polyvalent metal cation,
z_{S,j} is the amount of the charge number of the anionic and anionogenic group present in the polymeric dispersant, and
n_{S,j} is the number of moles of the anionic and anionogenic group present in the polymeric dispersant,
the indices i and j are independent of one another and are an integer greater than 0, where i is the number of different polyvalent metal cations and j is the number of different anionic and anionogenic groups present in the polymeric dispersant.
z_{K,i} is defined such that the charge number for metal cations always relates to the full formal charge, i.e. z_{Fe}(FeCl₃)=3, z_{Fe}(FeCl₂)=2.

The charge number z_{S,j} stands for the amount of the formal charge in the case of maximum deprotonation of the anionic and anionogenic group present in the polymeric dispersant, i.e. in the case, for example, of the groups (—OPO₃H₂), (—OPO₃H⁻), (—OPO₃²⁻), (—PO₃H₂), (—PO₃H⁻), and (—PO₃²⁻), z is 2, and in the case of the groups (—COOH) and (—COO⁻), z is 1.

2. The composition according to embodiment 1, the polyvalent metal cation being selected from the group of Al³⁺, Fe³⁺, Fe²⁺, Mn²⁺, Zn²⁺, Ca²⁺ and mixtures thereof.

3. The composition according to embodiment 2, the polyvalent metal cation being selected from the group of Al³⁺, Fe³⁺, Fe²⁺, Ca²⁺ and mixtures thereof.

4. The composition according to claim 1, the polyvalent metal cation and the anion being present in amounts which are calculated according to the following formulae:

$$\begin{matrix}0.1 < \frac{{Σ}_{i} {z}_{K , i} {n}_{K , i}}{{Σ}_{j} {z}_{s , j} {n}_{s , j}} \leq 30 & ( a ) \\ 0.01 < \frac{{Σ}_{l} {z}_{A , l} {n}_{A , l}}{{Σ}_{j} {z}_{K , i} {n}_{K , i}} \leq 3 & ( b )\end{matrix}$$

the relation according to formula (b) preferably being between 0.05 and 1.5, more preferably between 0.1 and 1.0, especially preferably between 0.15 and 0.8 and very preferably between 0.2 and 0.75, and where
z_{K,i} is the amount of the charge number of the polyvalent metal cation,
n_{K,i} is the number of moles of the polyvalent metal cation,
z_{S,j} is the charge number of the anionic and anionogenic groups present in the polymeric dispersant,
n_{S,j} is the number of moles of the anionic and anionogenic groups present in the polymeric dispersant,
z_{A,l} is the charge number of the anion,
n_{A,l} is the number of moles of the anion,
the indices i, j and l are independent of one another and are an integer greater than 0, i is the number of different polyvalent metal cations, j is the number of different anionic and anionogenic groups present in the polymeric dispersant, and l is the number of different anions which are able to form a sparingly soluble salt with the metal cation.

The charge number z_{A,l} stands for the amount of the formal charge in the case of maximum deprotonation, i.e., in the case, for example, of the groups (H₃PO₄) and (Na₃PO₄), z_{PO4} is 3, or in the case of (Na₂CO₃), z_{CO3} is 2. In the case of aluminate, z_{AlO2}(NaAlO₂)=z_{AlO2}(NaAl(OH)₄)=1; in the case of silicate, for all silicate species, z_{SiO3}(Na₂SiO₃)=2.

5. The composition according to any of the preceding embodiments, the relation according to formula (a) being in the range from 0.1 to 25, preferably 0.3 to 24, more preferably 0.5 to 23, with further preference 0.6 to 15 and with particular preference in the range from 0.75 to 5.

6. The composition according to any of the preceding embodiments, the anion being at least one from the group of carbonate, oxalate, silicate, phosphate, polyphosphate, phosphite, borate, aluminate, ferrate, zincate and sulfate.

7. The composition according to embodiment 6, the anion being at least one from the group of carbonate, silicate, phosphate, aluminate, ferrate and zincate.

8. The composition according to embodiment 7, the anion being phosphate or aluminate.

9. The composition according to any of the preceding embodiments, the amount of the additive in the composition of the invention being from 0.01 to 4 wt %, preferably 0.05 to 1.5 wt % and more particularly 0.075 to 1 wt %.

10. The composition according to any of the preceding claims, the at least one polyvalent metal cation and the anion being present in the additive in amounts which are calculated according to the following formula:

$$0.25 < \frac{{( {Σ}_{i} {z}_{K , i} {n}_{K , i} )}^{2}}{( {Σ}_{l} {z}_{A , l} {n}_{A , l} ) ( {Σ}_{j} {z}_{s , j} {n}_{s , j} )} < 25 \qquad ( c )$$

where the relation according to formula (c) is preferably in the range from 0.4 to 20 and more preferably in the range from 1 to 10.

11. The composition according to any of the preceding embodiments, having preferably a more than six month storage stability under atmospheric pressure, the storage stability being measured at 40° C.

12. The composition according to any of the preceding embodiments, the additive comprising substantially no preparation of an Al³⁺, Ca²⁺ or Mg²⁺ salt and of a silicate.

13. The composition according to embodiment 12, the sum total in the numerator of the formula (a) being at least 200 times greater than the part of the sum total in the numerator of the formula (a) that is accounted for by the preparations of the Al³⁺, Ca²⁺ or Mg²⁺ salts and of the silicate.

14. The composition according to embodiment 13, the sum total in the numerator of the formula (a) being at least 1000 times greater than the part of the sum total in the numerator of the formula (a) that is accounted for by the preparations of the Al³⁺, Ca²⁺ or Mg²⁺ salts and of the silicate.

15. The composition according to any of the preceding claims, the additive further comprising at least one pH neutralizer.

16. The composition according to embodiment 15, the pH neutralizer being at least one from the group of alkali metal hydroxide, organic monoamine, organic diamine, organic polyamine or ammonia.

17. The composition according to embodiment 16, the pH neutralizer being selected from sodium hydroxide, potassium hydroxide, ammonia, monohydroxy-C₁-C₄-alkylamines, dihydroxy-C₁-C₄-alkylamines, trihydroxy-C₁-C₄-alkylamines, mono-C₁-C₄-alkylamines, di-C₁-C₄-alkylamines, tri-C₁-C₄-alkylamines, C₁-C₄-alkylenediamines, (tetrahydroxy-C₁-C₄-alkyl)-C₁-C₄-alkylenediamines, polyethylenamines, polypropylenamines and mixtures thereof.

18. The composition according to embodiment 17, the pH neutralizer being selected from sodium hydroxide, potassium hydroxide, ammonia, monohydroxy-C₁-C₄-alkylamines, dihydroxy-C₁-C₄-alkylamines, trihydroxy-C₁-C₄-alkylamines, C₁-C₄-alkylenediamines, polyethylenamines and mixtures thereof.

19. The composition according to embodiment 18, the pH neutralizer being selected from sodium hydroxide, potassium hydroxide, ammonia, ethylenediamine, monoethanolamine, diethanolamine, triethanolamine, polyethylenamines and mixtures thereof.

20. The composition according to embodiment 19, the pH neutralizer being selected from sodium hydroxide and potassium hydroxide and mixtures thereof.

21. The composition according to embodiment 20, the pH neutralizer being sodium hydroxide.

22. The composition according to any of the preceding embodiments, a 1-molar suspension of the additive in water having a pH of 2 to 12, preferably 3 to 11 and more particularly 4 to 10.

23. The composition according to any of the preceding claims, the polymeric dispersant comprising as anionic or anionogenic group at least one structural unit of the general formulae (Ia), (Ib), (Ic) and/or (Id):

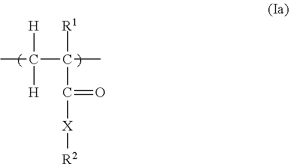

in which
R¹ is H or an unbranched or branched C₁-C₄ alkyl group, CH₂COOH or CH₂CO—X—R²;
X is NR³—(CₙH₂ₙ) or O(CₙH₂ₙ) with n=1, 2, 3 or 4, the nitrogen atom or the oxygen atom, respectively, being attached to the CO group;
R² is PO₃M₂, O—PO₃M₂, (C₆H₄)—PO₃M₂ or (C₆H₄)—OPO₃M₂; or X is a chemical bond and R² is OM;
R³ is H, C₁-C₆ alkyl, (CₙH₂ₙ)—OH, (CₙH₂O—PO₃M₂, (CₙH₂O—OPO₃M₂, (C₆H₄)—PO₃M₂, (C₆H₄)—OPO₃M₂ or (CₙH₂ₙ)—O-(AO)α-R⁴;
α is an integer from 1 to 350;
R⁴ is H or an unbranched or branched C₁-C₄ alkyl group; and
M independently at each occurrence is H or one cation equivalent;

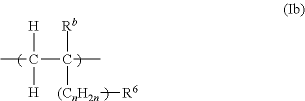

in which
R⁵ is H or an unbranched or branched C₁-C₄ alkyl group;
n is 0, 1, 2, 3 or 4;
R⁶ is PO₃M₂ or O—PO₃M₂; and
M independently at each occurrence is H or one cation equivalent;

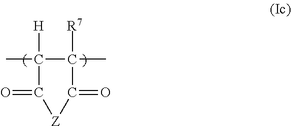

in which
R⁷ is H or an unbranched or branched C₁-C₄ alkyl group;
Z is O or NR^{B}; and
R⁸ is H, (CₙH₂ₙ)—OH, (CₙH₂ₙ)—PO₃M₂, (CₙH₂ₙ)—OPO₃M₂, (C₆H₄)—PO₃M₂, or (C₆H₄)—OPO₃M₂;
n is 1, 2, 3 or 4, and
M independently at each occurrence is H or one cation equivalent;

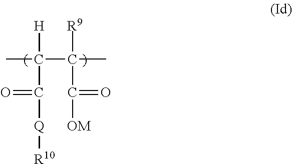

in which
R⁹ is H or an unbranched or branched C₁-C₄ alkyl group;
Q is NR¹⁰ or O;
R¹⁰ is H, (CₙH₂ₙ)—OH, (CₙH₂ₙ)—PO₃M₂, (CₙH₂ₙ)—OPO₃M₂, (C₆H₄)—PO₃M₂, (C₆H₄)—OPO₃M₂ or (CₙH₂ₙ)—O-(AO)_{β}—R¹¹;
A is CₓH₂ₓ with x=2, 3, 4 or 5 or is CH₂CH(C₆H₅);
β is an integer from 1 to 350;
R¹¹ is H or an unbranched or branched C₁-C₄ alkyl group;
n is 1, 2, 3 or 4; and
M independently at each occurrence is H or one cation equivalent.

24. The composition according to embodiment 23, the polymeric dispersant comprising as anionic or anionogenic group at least one structural unit of the formula (Ia) in which R¹ is H or CH₃; and/or at least one structural unit of the formula (Ib) in which R⁵ is H or CH₃; and/or at least one structural unit of the formula (Ic) in which R⁷ is H or CH₃ and Z is O; and/or at least one structural unit of the formula (Id) in which R⁹ is H and Q is O.

25. The composition according to embodiment 23, the polymeric dispersant comprising as anionic or anionogenic group at least one structural unit of the formula (Ia) in which R¹ is H or CH₃ and XR² is OM or X is O(CₙH₂ₙ) with n=1, 2, 3 or 4, more particularly 2, and R² is O—PO₃M₂.

26. The composition according to any of the preceding embodiments, the polymeric dispersant comprising as polyether side chain at least one structural unit of the general formulae (IIa), (IIb), (IIc) and/or (IId):

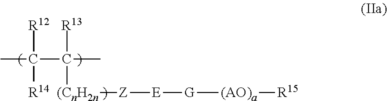

in which
R¹², R¹³ and R¹⁴ independently of one another are H or an unbranched or branched C₁-C₄ alkyl group;
E is an unbranched or branched C₁-C₆ alkylene group, a cyclohexylene group, CH₂—C₆H₁₀, 1,2-phenylene, 1,3-phenylene or 1,4-phenylene;
G is O, NH or CO—NH; or
   E and G together are a chemical bond;
Z is O or S;
A is CₓH₂ₓ with x=2, 3, 4 or 5 or is CH₂CH(C₆H₅);
n is 0, 1, 2, 3, 4 and/or 5;
a is an integer from 2 to 350; and
R¹⁵ is H, an unbranched or branched C₁-C₄ alkyl group, CO—NH₂ and/or COCH₃;

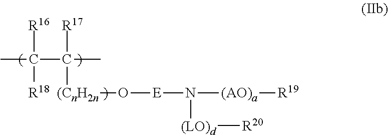

in which
R¹⁶, R¹⁷ and R¹⁸ independently of one another are H or an unbranched or branched C₁-C₄ alkyl group;
E is an unbranched or branched C₁-C₆ alkylene group, a cyclohexylene group, CH₂—C₆H₁₀, 1,2-phenylene, 1,3-phenylene or 1,4-phenylene or is a chemical bond;
A is CₓH₂ₓ with x=2, 3, 4 or 5 or is CH₂CH(C₆H₅);
L is CₓH₂ₓ with x=2, 3, 4 or 5 or is CH₂—CH(C₆H₅);
a is an integer from 2 to 350;
d is an integer from 1 to 350;
R¹⁹ is H or an unbranched or branched C₁-C₄ alkyl group;
R²⁰ is H or an unbranched or branched C₁-C₄ alkyl group; and
n is 0, 1, 2, 3, 4 or 5;

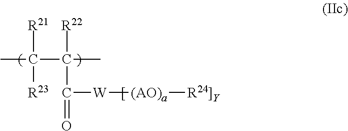

in which
R²¹, R²², and R²³ independently of one another are H or an unbranched or branched C₁-C₄ alkyl group;
W is O, NR²⁵ or N
Y is 1 if W=O or NR²⁵, and is 2 if W=N;
A is CₓH₂ₓ with x=2, 3, 4 or 5 or is CH₂CH(C₆H₅);
a is an integer from 2 to 350;
R²⁴ is H or an unbranched or branched C₁-C₄ alkyl group; and
R²⁵ is H or an unbranched or branched C₁-C₄ alkyl group;

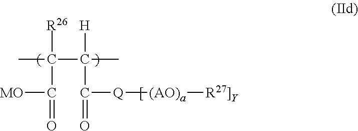

in which
R²⁶ is H or an unbranched or branched C₁-C₄ alkyl group;
Q is NR¹⁰, N or O;
Y is 1 if Q=O or NR²⁸, and is 2 if Q=N;
R²⁷ is H or an unbranched or branched C₁-C₄ alkyl group;
R²⁸ is H or an unbranched or branched C₁-C₄ alkyl group;
A is CₓH₂ₓ with x=2, 3, 4 or 5, or CH₂C(C₆H₅)H;
a is an integer from 2 to 350; and
M independently at each occurrence is H or one cation equivalent.

27. The composition according to embodiment 26, the polymeric dispersant comprising as polyether side chain:

(a) at least one structural unit of the formula (IIa) in which R¹² and R¹⁴ are H, R¹³ is H or CH₃, E and G together are a chemical bond or E is an unbranched or branched C₁-C₆ alkylene group and G is O, A is CₓH₂ₓ with x=2 and/or 3, a is 3 to 150, and R¹⁵ is H or an unbranched or branched C₁-C₄ alkyl group; and/or
(b) at least one structural unit of the formula (IIb) in which R¹⁶ and R¹⁸ are H, R¹⁷ is H or CH₃, E is an unbranched or branched C₁-C₆ alkylene group, A is CₓH₂ₓ with x=2 and/or 3, L is CₓH₂ₓ with x=2 and/or 3, a is an integer from 2 to 150, d is an integer from 1 to 150, R¹⁹ is H or an unbranched or branched C₁-C₄ alkyl group, and R²⁰ is H or an unbranched or branched C₁-C₄ alkyl group; and/or
(c) at least one structural unit of the formula (IIc) in which R²¹ and R²³ are H, R²² is H or CH₃, A is CₓH₂ₓ with x=2 and/or 3, a is an integer from 2 to 150, and R²⁴ is H or an unbranched or branched C₁-C₄ alkyl group; and/or
(d) at least one structural unit of the formula (IId) in which R²⁶ is H, Q is O, A is CₓH₂ₓ with x=2 and/or 3, a is an integer from 1 to 150.

28. The composition according to one of embodiments 26 or 27, the polymeric dispersant comprising at least one structural unit of the formula (IIa) and/or (IIc).

29. The composition according to any of the preceding claims, the polymeric dispersant being a polycondensation product comprising structural units (III) and (IV):

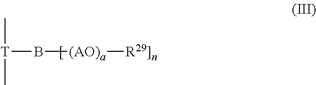

in which
T is a substituted or unsubstituted phenyl radical, substituted or unsubstituted naphthyl radical or a substituted or unsubstituted heteroaromatic radical having 5 to 10 ring atoms, of which 1 or 2 atoms are heteroatoms selected from N, O and S;
n is 1 or 2;
B is N, NH or O, with the proviso that n is 2 if B is N and with the proviso that n is 1 if B is NH or O;
A is CₓH₂ₓ with x=2, 3, 4 or 5 or is CH₂CH(C₆H₅);
a is an integer from 1 to 300; and
R²⁹ is H, a branched or unbranched C₁ to C₁₀ alkyl radical, C₅ to C₈ cycloalkyl radical, aryl radical, or heteroaryl radical having 5 to 10 ring atoms, of which 1 or 2 atoms are heteroatoms selected from N, O and S;
   the structural unit (IV) being selected from the structural units (IVa) and (IVb):

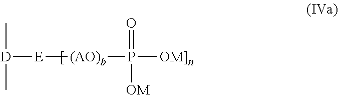

in which
D is a substituted or unsubstituted phenyl radical, substituted or unsubstituted naphthyl radical or a substituted or unsubstituted heteroaromatic radical having 5 to 10 ring atoms, of which 1 or 2 atoms are heteroatoms selected from N, O and S;
E is N, NH or O, with the proviso that n is 2 if E is N and with the proviso that
n is 1 if E is NH or O;
A is CₓH₂ₓ with x=2, 3, 4 or 5 or is CH₂CH(C₆H₅);
b is an integer from 1 to 300; and
M independently at each occurrence is H or one cation equivalent;

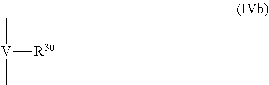

in which
V is a substituted or unsubstituted phenyl radical, substituted or unsubstituted naphthyl radical and is optionally substituted by 1 or two radicals selected from R³¹, OH, OR³¹, (CO)R³¹, COOM, COOR³¹, SO₃R³¹ and NO₂;
R³⁰ is COOM, OCH₂COOM, SO₃M or OPO₃M₂;
R³¹ is C₁-C₄ alkyl, phenyl, naphthyl, phenyl-C₁-C₄ alkyl or C₁-C₄ alkylphenyl; and
M independently at each occurrence is H or one cation equivalent.

30. The composition according to embodiment 29, T in the structural unit (Ill) being a substituted or unsubstituted phenyl radical or naphthyl radical, B being NH or O, A being CₓH₂ₓ with x=2 and/or 3, a being an integer from 1 to 150, and R²⁹ being H, or a branched or unbranched C₁ to C₁₀ alkyl radical.

31. The composition according to embodiment 29, D in the structural unit (IVa) being a substituted or unsubstituted phenyl radical or naphthyl radical, E being NH or O, A being CₓH₂ₓ with x=2 and/or 3, and b being an integer from 1 to 150.

32. The composition according to embodiment 29, T and/or D being phenyl or naphthyl which is substituted by 1 or 2 C₁-C₄ alkyl, hydroxy or 2 C₁-C₄ alkoxy groups.

33. The composition according to embodiment 29, V in the structural unit (IVb) being phenyl or naphthyl which is substituted by 1 or 2 C₁-C₄ alkyl, OH, OCH₃ or COOM, and R³⁰ being COOM or OCH₂COOM.

34. The composition according to any of embodiments 29 to 33, the polycondensation product comprising a further structural unit (V) of the formula

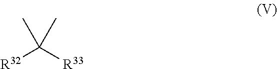

in which
R³² and R³³ may be identical or different and are H, CH₃, COOH or are a substituted or unsubstituted phenyl or naphthyl group.

35. The composition according to embodiment 34, in which R³² and R³³ may be identical or different and are H, CH₃, or COOH, more particularly H, or one of the radicals R³² and R³³ is H and the other is CH₃.

36. The composition according to any of embodiments 1 to 28, the polymeric dispersant comprising structural units of the formulae (Ia) and (IIa).

37. The composition according to any of embodiments 1 to 28, the polymeric dispersant comprising structural units of the formulae (Ia) and (IIc).

38. The composition according to any of embodiments 1 to 28, the polymeric dispersant comprising structural units of the formulae (Ic) and (IIa).

39. The composition according to any of embodiments 1 to 28, the polymeric dispersant comprising structural units of the formulae (Ia), (Ic) and (IIa).

40. The composition according to any of embodiments 1 to 28, the polymeric dispersant being constructed from (i) anionic or anionogenic structural units derived from acrylic acid, methacrylic acid, maleic acid, hydroxyethyl acrylate phosphoric esters and/or hydroxyethyl methacrylate phosphoric esters, hydroxyethyl acrylate phosphoric diesters, and/or hydroxyethyl methacrylate phosphoric diesters, and (ii) polyether side chain structural units derived from C₁-C₄-alkylpolyethylene glycol acrylic esters, polyethylene glycol acrylic esters, C₁-C₄-alkylpolyethylene glycol methacrylic esters, polyethylene glycol methacrylic esters, C₁-C₄-alkylpolyethylene glycol acrylic esters, polyethylene glycol acrylic esters, vinyloxy-C₂-C₄-alkylenepolyethylene glycol, vinyloxy-C₂-C₄-alkylenepolyethylene glycol C₁-C₄-alkyl ethers, allyloxypolyethylene glycol, allyloxypolyethylene glycol C₁-C₄-alkyl ethers, methallyloxypolyethylene glycol, methallyloxypolyethylene glycol C₁-C₄-alkyl ethers, isoprenyloxypolyethylene glycol and/or isoprenyloxypolyethylene glycol C₁-C₄-alkyl ethers.

41. The composition according to embodiment 40, the polymeric dispersant being constructed from structural units (i) and (ii) derived from
(i) hydroxyethyl acrylate phosphoric esters and/or hydroxyethyl methacrylate phosphoric esters and (ii) C₁-C₄-alkylpolyethylene glycol acrylic esters and/or C₁-C₄-alkylpolyethylene glycol methacrylic esters; or
(i) acrylic acid and/or methacrylic acid and (ii) C₁-C₄-alkylpolyethylene glycol acrylic esters and/or C₁-C₄-alkylpolyethylene glycol methacrylic esters; or
(i) acrylic acid, methacrylic acid and/or maleic acid and (ii) vinyloxy-C₂-C₄-alkylene-polyethylene glycol, allyloxypolyethylene glycol, methallyloxypolyethylene glycol and/or isoprenyloxypolyethylene glycol.

42. The composition according to embodiment 40, the polymeric dispersant being constructed from structural units (i) and (ii) derived from
(i) hydroxyethyl methacrylate phosphoric esters and (ii) C₁-C₄-alkylpolyethylene glycol methacrylic esters or polyethylene glycol methacrylic esters; or
(i) methacrylic acid and (ii) C₁-C₄-alkylpolyethylene glycol methacrylic esters or polyethylene glycol methacrylic esters; or
(i) acrylic acid and maleic acid and (ii) vinyloxy-C₂-C₄-alkylenepolyethylene glycol or
(i) acrylic acid and maleic acid and (ii) isoprenyloxypolyethylene glycol or
(i) acrylic acid and (ii) vinyloxy-C₂-C₄-alkylenepolyethylene glycol or
(i) acrylic acid and (ii) isoprenyloxypolyethylene glycol or
(i) acrylic acid and (ii) methallyloxypolyethylene glycol or
(i) maleic acid and (ii) isoprenyloxypolyethylene glycol or
(i) maleic acid and (ii) allyloxypolyethylene glycol or
(i) maleic acid and (ii) methallyloxypolyethylene glycol.

43. The composition according to any of embodiments 23 to 28, the molar ratio of the structural units (I):(II) being 1:4 to 15:1, more particularly 1:1 to 10:1.

44. The composition according to any of embodiments 29 to 35, the molar ratio of the structural units (III):(IV) being 4:1 to 1:15, more particularly 2:1 to 1:10.

45. The composition according to any of embodiments 34 to 35, the molar ratio of the structural units (III+IV):(V) being 2:1 to 1:3, more particularly 1:0.8 to 1:2.

46. The composition according to any of embodiments 29 to 35 or 45, the polymeric dispersant being constructed from structural units of the formulae (III) and (IVa) in which T and D are phenyl or naphthyl, the phenyl or naphthyl being optionally substituted by 1 or 2 C₁-C₄ alkyl, hydroxy or 2 C₁-C₄ alkoxy groups, B and E are O, A is CₓH₂ₓ with x=2, a is 3 to 150, more particularly 10 to 150, and b is 1, 2 or 3.

47. The composition according to any of the preceding embodiments, characterized in that the binder based on calcium sulfate comprises α-hemihydrate, α/β-hemihydrate, β-hemihydrate, natural anhydrite, synthetic anhydrite, anhydrite obtained from flue gas desulfurization, and/or mixtures of two or more thereof.

48. The composition according to any of the preceding embodiments, characterized in that it comprises at least one further binder from the series of Portland cement, white cement, calcium aluminate cement, calcium sulfoaluminate cement, and pozzolanic binders such as flyash, metakaolin, silica dust and slag sand.

49. The composition according to any of the preceding embodiments, characterized in that it comprises at least one compound from the series of silica sand, finely ground quartz, limestone, heavy spar, calcite, aragonite, vaterite, dolomite, talc, kaolin, mica, chalk, titanium dioxide, rutile, anatase, aluminum hydroxide, aluminum oxide, magnesium hydroxide and brucite.

50. A process for preparing a composition according to any of the preceding embodiments, characterized in that
a) the at least one water-soluble salt of a polyvalent metal cation,
b) the at least one compound able to release an anion which forms a sparingly soluble salt with the polyvalent metal cation, and
c) the at least one polymeric dispersant which comprises anionic and/or anionogenic groups and polyether side chains, are contacted with one another in the presence of water, and the resulting additive is contacted
d) with the further components of the composition, comprising the binder based on calcium sulfate.

51. The process according to embodiments 50, the at least one salt of the polyvalent metal cation being precipitated in the presence of the polymeric dispersant.

52. The process according to embodiments 50, the at least one polyvalent metal cation first being contacted with the at least one compound capable of releasing an anion, and then the polymeric dispersant being added.

53. The process according to any of embodiments 50 to 52, a pH neutralizer being added during the preparation of the additive.

54. The process according to any of embodiments 50 to 53, a hydroxide and/or oxide of the polyvalent metal cation being peptized with an acid, to give a colloidally disperse preparation of the salt of the polyvalent metal cation.

55. The process according to embodiment 54, the acid being selected from boric acid, carbonic acid, oxalic acid, silicic acid, sulfuric acid, polyphosphoric acid, phosphoric acid and/or phosphorous acid.

56. The process according to embodiment 54, the acidic form of the polymeric dispersant being used for peptizing the hydroxide and/or oxide of the polyvalent metal cation.

57. The process according to any of embodiments 50 to 56, the at least one water-soluble salt of a polyvalent metal cation comprising an Al³⁺ salt.

58. The process according to any of embodiments 50 to 56, the at least one water-soluble salt of a polyvalent metal cation comprising an Fe³⁺ salt.

59. The process according to any of embodiments 50 to 56, the at least one water-soluble salt of a polyvalent metal cation comprising an Fe²⁺ salt.

60. The process according to any of embodiments 50 to 56, the at least one water-soluble salt of a polyvalent metal cation comprising a Ca²⁺ salt.

61. The process according to any of embodiments 50 to 60, the anion being at least one from the group of carbonate, oxalate, silicate, phosphate, polyphosphate, phosphite, borate, aluminate, ferrate, zincate and sulfate, more particularly phosphate or aluminate.

62. The process according to embodiment 61, the anion being phosphate and the relation according to formula (b) being in the range from 0.1 to 2.

63. The process according to embodiment 61, the anion being phosphate and the relation according to formula (b) being in the range of 0.1 and 1.0.

64. The process according to embodiment 61, the anion being phosphate and the relation according to formula (b) being in the range from 0.2 to 0.75.

65. The process according to embodiment 61, the anion being aluminate and the relation according to formula (b) being in the range from 0.1 to 2.

66. The process according to embodiment 61, the anion being aluminate and the relation according to formula (b) being in the range of 0.1 and 1.0.

67. The process according to embodiment 61, the anion being aluminate and the relation according to formula (b) being in the range from 0.2 to 0.75.

68. The use of the additive in a composition according to any of embodiments 1 to 49 as a slump retainer.

69. The use of a composition according to any of embodiments 1 to 49 as self-leveling calcium sulfate screed, flowable calcium sulfate filling compound, and calcium sulfate screed of damp-soil consistency.

The sum of the product of charge number z_{S,j} and number of mole n_{S,j} in mmol/g in the polymeric dispersant can be determined by various known methods, as for example by determination by charge density titration with a polycation as described for example in J. Plank et al., Cem. Concr. Res. 2009, 39, 1-5. Moreover, the skilled person familiar with the state of the art is capable of determining this value in a simple calculation from the initial weightings of monomers for the synthesis of the polymeric dispersant. Lastly it is possible to obtain the numerical value of the sum of the product of zₛ and nₛ experimentally, by determining the ratios of the polymer units by means of nuclear magnetic resonance spectroscopy (NMR). This is done by utilizing in particular the integration of the signals in the ¹H-NMR spectrum of a dissolved polymeric dispersant.

The polyvalent metal cation is preferably selected from Al³⁺, Fe³⁺, Fe²⁺, Zn²⁺, Mn²⁺, Cu²⁺, Ca²⁺, Mg²⁺, Sr²⁺, Ba²⁺ and mixtures thereof, more preferably selected from Al³⁺, Fe³⁺, Fe²⁺, Mn²⁺, Zn²⁺, Ca²⁺ and mixtures thereof, very preferably selected from Al³⁺, Fe³⁺, Fe²⁺, Ca²⁺ and mixtures thereof.

The counteranion of the at least one water-soluble salt of the polyvalent metal cation is preferably selected such that the salts are readily water-soluble, the solubility in water at 20° C., pH 3 and atmospheric pressure being preferably greater than 10 g/l, more preferably greater than 100 g/l and very preferably greater than 200 g/l. The numerical value of the solubility relates here to the total mass of dissolved metal cations and counteranions that comes about in the equilibrium state when the water-soluble salt is dissolved in deionized water at 20° C., pH 3 under atmospheric pressure. The solubility takes no account of the effects of protonation equilibriums (pH) and complexation equilibriums.

The counteranion of the water-soluble salt of the polyvalent metal cation is preferably singly charged and selected from nitrate, acetate, formate, hydrogensulfate, halide, halate, cyanide, azide, cyanate, thiocyanate, fulminate, methanesulfonate and/or amidosulfonate. With particular preference the counteranion is selected from chloride and nitrate. With very particular preference the counteranion is nitrate. Double salts as well can be used as salts of polyvalent metal cations. Double salts are salts which have two or more different cations. An example is alum (KAI(SO₄)₂.12H₂O), which is suitable as an aluminum salt. The salts of polyvalent metal cations with the aforementioned counteranions are readily water-soluble and hence especially suitable, since relatively high concentrations of the aqueous metal salt solutions (as reactant) can be established.

Anionic groups are the deprotonated acid groups present in the polymeric dispersant. Anionogenic groups are the acid groups present in the polymeric dispersant. Groups which are both anionic and anionogenic, such as partially deprotonated polybasic acid residues, are assigned exclusively to the anionic groups when forming the sum of the number of moles of the anionic and anionogenic groups present in the polymeric dispersant.

The term “different kinds of polyvalent metal cations” refers to polyvalent metal cations of different elements. Furthermore, the term “different kinds of polyvalent metal cations” also refers to metal cations of the same element with different charge numbers.

Anionic and anionogenic groups of the polymeric dispersant are said to be of different kinds when they cannot be converted into one another by protonation.

The relation of formula (a)

$$0.1 < \frac{{Σ}_{i} {z}_{K , i} {n}_{K , i}}{{Σ}_{j} {z}_{s , j} {n}_{s , j}} \leq 30 \qquad ( a )$$

is preferably in the range from 0.1 to 25, more preferably 0.3 to 24, very preferably 0.5 to 23, with further preference 0.6 to 15, and with more particular preference in the range from 0.75 to 5.

The relation of formula (b)

$$0.01 < \frac{{Σ}_{l} {z}_{A , l} {n}_{A , l}}{{Σ}_{j} {z}_{K , i} {n}_{K , i}} \leq 3 \qquad ( b )$$

is preferably between 0.05 and 1.5, more preferably between 0.1 and 1.0, with particular preference between 0.15 to 0.8, and with very particular preference between 0.2 and 0.75.

Any range for formula (a) may be combined with any range for formula (b).

In the present invention, a sparingly soluble salt is a salt whose solubility in water at 20° C., pH 9 and atmospheric pressure is less than 5 g/l, preferably less than 1 g/l.

A water-soluble salt is a salt whose solubility in water at 20° C., pH 3 and atmospheric pressure is greater than 5 g/l.

The anion is preferably at least one from the group of carbonate, oxalate, silicate, phosphate, polyphosphate, phosphite, borate, aluminate, ferrate, zincate and sulfate, preferably carbonate, silicate, phosphate, aluminate, ferrate and zincate. More preferably the anion is phosphate or aluminate.

The stated anions also include the polymeric borate, silicate and oxalate anions, and also the polyphosphates. The term “polymeric anions” refers to anions which as well as oxygen atoms comprise at least two atoms from the group consisting of boron, carbon, silicon and phosphorus. With particular preference they are oligomers having a number of atoms of between 2 and 20, more particularly preferably 2 to 14 atoms, most preferably 2 to 5 atoms. The number of atoms in the case of the silicates is more preferably in the range from 2 to 14 silicon atoms, and in the case of the polyphosphates it is more preferably in the range from 2 to 5 phosphorus atoms.

A compound able to release a silicate is Na₂SiO₃ and waterglass with a modulus, defined as the ratio of SiO₂ to alkali metal oxide, in the range from 1/1 to 4/1, more preferably 1/1 to 3/1.

With the silicates it is possible for some of the silicon atoms in the silicates to be replaced by aluminum. Such compounds are known from the class of the aluminosilicates. The fraction of aluminum is preferably less than 10 mol %, based on the sum of silicon and aluminum, and more preferably the aluminum fraction is zero.

It has proved to be advantageous if the anion is phosphate and the relation according to formula (b) is in the range from 0.1 to 2.

It has further proved to be advantageous if the anion is phosphate and the relation according to formula (b) is in the range from 0.1 to 1.0.

It has proved to be particularly advantageous if the anion is phosphate and the relation according to formula (b) is in the range from 0.2 to 0.75.

It has proved in a further embodiment to be advantageous if the anion is aluminate and the relation according to formula (b) is in the range from 0.1 to 2.

It has further proved to be advantageous if the anion is aluminate and the relation according to formula (b) is in the range from 0.1 to 1.0.

It has proved to be particularly advantageous if the anion is aluminate and the relation according to formula (b) is in the range from 0.2 to 0.75.

The countercation of the compound which is able to release the anion is preferably a singly charged cation or a proton, preferably an alkali metal cation and/or ammonium ion and/or a proton, more preferably a proton. The ammonium ion may also comprise an organic ammonium ion, examples being alkylammonium ions having one to four alkyl radicals. The organic radical may also be of aromatic type or comprise aromatic radicals. The ammonium ion may also be an alkanolammonium ion.

The additive for hydraulically setting compositions may further comprise at least one pH neutralizer.

The pH neutralizer is preferably an alkali metal hydroxide, an organic monoamine, an organic diamine, an organic polyamine or ammonia. Suitable organic amines are more particularly an aliphatic monoamine, aliphatic diamine or an aliphatic polyamine. Polyamines include triamines.

The pH neutralizer is further preferably selected from sodium hydroxide, potassium hydroxide, ammonia, monohydroxy-C₁-C₄ alkylamines, dihydroxy-C₁-C₄ alkylamines, trihydroxy-C₁-C₄ alkylamines, mono-C₁-C₄ alkylamines, di-C₁-C₄ alkylamines, tri-C₁-C₄ alkylamines, C₁-C₄ alkylenediamines, (tetrahydroxy-C₁-C₄ alkyl)-C₁-C₄ alkylenediamines, polyethylenamines, polypropylenamines and mixtures thereof.

More preferably the pH neutralizer is selected from sodium hydroxide, potassium hydroxide, ammonia, monohydroxy-C₁-C₄ alkylamines, dihydroxy-C₁-C₄ alkylamines, trihydroxy-C₁-C₄ alkylamines, C₁-C₄ alkylenediamines, polyethylenamines and mixtures thereof.

Particularly preferably the pH neutralizer is selected from sodium hydroxide, potassium hydroxide, ammonia, ethylenediamine, monoethanolamine, diethanolamine, triethanolamine, polyethylenamines and mixtures thereof.

Very particularly preferably the pH neutralizer is selected from sodium hydroxide and potassium hydroxide and mixtures thereof. Most preferably the pH neutralizer is sodium hydroxide.

The additive as a 1-molar suspension in water preferably has a pH of 2 to 12, preferably 3 to 11, more particularly 4 to 10.

In one embodiment the polymeric dispersant comprises at least one structural unit of the general formulae (Ia), (Ib), (Ic) and/or (Id), it being possible for the structural units (Ia), (Ib), (Ic) and (Id) to be the same or different both within individual polymer molecules and between different polymer molecules.

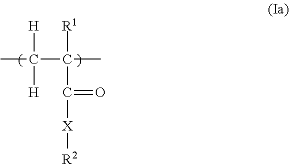

in which
R¹ is H or an unbranched or branched C₁-C₄ alkyl group, CH₂COOH or CH₂CO—X—R²;
X is NR³—(CₙH₂ₙ) or O(CₙH₂ₙ) with n=1, 2, 3 or 4, the nitrogen atom or oxygen atom being attached to the CO group;
R² is PO₃M₂, O—PO₃M₂, (C₆H₄)—PO₃M₂ or (C₆H₄)—OPO₃M₂; or X is a chemical bond and R² is OM;
R³ is H, C₁-C₆ alkyl, (CₙH₂ₙ)—OH, (CₙH₂ₙ)—PO₃M₂, (CₙH₂ₙ)—OPO₃M₂, (C₆H₄)—PO₃M₂, (C₆H₄)—OPO₃M₂ or (CₙH₂ₙ)—O-(AO)_{α}—R⁴;
α is an integer from 1 to 350;
R⁴ is H or an unbranched or branched C₁-C₄ alkyl group; and
M independently at each occurrence is H or one cation equivalent;

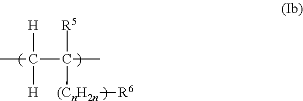

in which
R⁵ is H or an unbranched or branched C₁-C₄ alkyl group;
n is 0, 1, 2, 3 or 4;
R⁶ is PO₃M₂ or O—PO₃M₂; and
M independently at each occurrence is H or one cation equivalent;

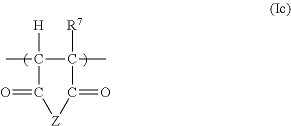

in which
R⁷ is H or an unbranched or branched C₁-C₄ alkyl group;
Z is O or NR⁸; and
R⁸ is H, (CₙH₂ₙ)—OH, (CₙH₂ₙ)—PO₃M₂, (CₙH₂ₙ)—OPO₃M₂, (C₆H₄)—PO₃M₂, or (C₆H₄)—OPO₃M₂;
n is 1, 2, 3 or 4, and
M independently at each occurrence is H or one cation equivalent;

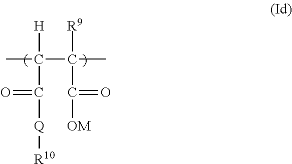

in which
R⁹ is H or an unbranched or branched C₁-C₄ alkyl group;
Q is NR¹⁰ or O;
R¹⁰ is H, (CₙH₂ₙ)—OH, (CₙH₂ₙ)—PO₃M₂, (CₙH₂ₙ)—OPO₃M₂, (C₆H₄)—PO₃M₂, (C₆H₄)—OPO₃M₂ or (CₙH₂ₙ)—O-(AO)_{β}—R¹¹;
A is CₓH₂ₓ with x=2, 3, 4 or 5 or is CH₂CH(C₆H₅);
β is an integer from 1 to 350;
R¹¹ is H or an unbranched or branched C₁-C₄ alkyl group;
n is 1, 2, 3 or 4; and
M independently at each occurrence is H or one cation equivalent.

With particular preference, the structural unit of formula (Ia) is a methacrylic acid or acrylic acid unit, the structural unit of formula (Ic) is a maleic anhydride unit, and the structural unit of formula (Id) is a maleic acid or maleic monoester unit.

Where the monomers (I) are phosphoric esters or phosphonic esters, they may also include the corresponding diesters and triesters and also the monoester of diphosphoric acid. These esters come about in general during the esterification of organic alcohols with phosphoric acid, polyphosphoric acid, phosphorus oxides, phosphorus halides or phosphorus oxyhalides, and/or the corresponding phosphonic acid compounds, alongside the monoester, in different proportions, as for example 5-30 mol % of diester and 1-15 mol % of triester and also 2-20 mol % of the monoester of diphosphoric acid.

In one embodiment the polymeric dispersant comprises at least one structural unit of the general formulae (IIa), (IIb), (IIc) and/or (IId). The general formulae (IIa), (IIb), (IIc) and (IId) may be identical or different not only within individual polymer molecules but also between different polymer molecules. All structural units A may be identical or different both within individual polyether side chains and between different polyether side chains.

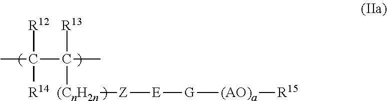

in which
R¹², R¹³ and R¹⁴ independently of one another are H or an unbranched or branched C₁-C₄ alkyl group;
E is an unbranched or branched C₁-C₆ alkylene group, a cyclohexylene group, CH₂—C₆H₁₀, 1,2-phenylene, 1,3-phenylene or 1,4-phenylene;
G is O, NH or CO—NH; or
   E and G together are a chemical bond;
Z is O or S;
A is CₓH₂ₓ with x=2, 3, 4 or 5, or is CH₂CH(C₆H₅);
n is 0, 1, 2, 3, 4 and/or 5;
a is an integer from 2 to 350; and
R¹⁵ is H, an unbranched or branched C₁-C₄ alkyl group, CO—NH₂ and/or COCH₃;

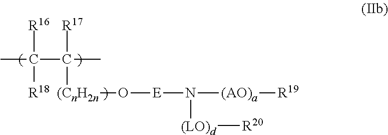

in which
R¹⁶, R¹⁷ and R¹⁸ independently of one another are H or an unbranched or branched C₁-C₄ alkyl group;
E is an unbranched or branched C₁-C₆ alkylene group, a cyclohexylene group, CH₂—C₆H₁₀, 1,2-phenylene, 1,3-phenylene or 1,4-phenylene or is a chemical bond;
A is CₓH₂ₓ with x=2, 3, 4 or 5 or is CH₂CH(C₆H₅);
L is CₓH₂ₓ with x=2, 3, 4 or 5 or is CH₂—CH(C₆H₅);
a is an integer from 2 to 350;
d is an integer from 1 to 350;
R¹⁹ is H or an unbranched or branched C₁-C₄ alkyl group;
R²⁰ is H or an unbranched C₁-C₄ alkyl group; and
n is 0, 1, 2, 3, 4 or 5;

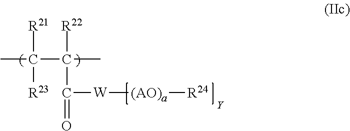

in which
R²¹, R²² and R²³ independently of one another are H or an unbranched or branched C₁-C₄ alkyl group;
W is O, NR²⁵ or N
Y is 1 if W=O or NR²⁸, and is 2 if W=N;
A is CₓH₂ₓ with x=2, 3, 4 or 5 or is CH₂CH(C₆H₅);
a is an integer from 2 to 350;
R²⁴ is H or an unbranched or branched C₁-C₄ alkyl group; and
R²⁵ is H or an unbranched or branched C₁-C₄ alkyl group;

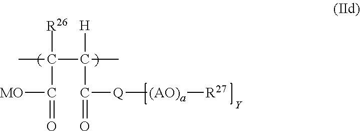

in which
R²⁶ is H or an unbranched or branched C₁-C₄ alkyl group; Q is NR¹⁰, N or O;
Y is 1 if Q=O or NR¹⁰, and is 2 if Q=N;
R²⁷ is H or an unbranched or branched C₁-C₄ alkyl group;
R²⁸ is H or an unbranched or branched C₁-C₄ alkyl group;
A is CₓH₂ₓ with x=2, 3, 4 or 5, or CH₂C(C₆H₅)H;
a is an integer from 2 to 350; and
M independently at each occurrence is H or one cation equivalent.

Besides the structural units of the formulae (I) and (II), the polymeric dispersant may also comprise further structural units which derive from radically polymerizable monomers, such as hydroxyethyl(meth)acrylate, hydroxypropyl(meth)acrylate, (meth)acrylamide, (C₁-C₄) alkyl(meth)acrylates, styrene, styrenesulfonic acid, 2-acrylamido-2-methylpropanesulfonic acid, (meth)allylsulfonic acid, vinylsulfonic acid, vinyl acetate, acrolein, N-vinylformamide, vinylpyrrolidone, (meth)allyl alcohol, isoprenol, 1-butyl vinyl ether, isobutyl vinyl ether, aminopropyl vinyl ether, ethylene glycol monovinyl ether, 4-hydroxybutyl monovinyl ether, (meth)acrolein, crotonaldehyde, dibutyl maleate, dimethyl maleate, diethyl maleate and dipropyl maleate.

The average molecular weight M_{w} of the polymeric dispersant, preferably of the water-soluble polymeric dispersant, as determined by gel permeation chromatography (GPC), is preferably 5000 to 200 000 g/mol, more preferably 10 000 to 80 000 g/mol, and very preferably 20 000 to 70 000 g/mol. The average molar mass of the polymers determined by means of size exclusion chromatography (column combinations: OH-Pak SB-G, OH-Pak SB 804 HQ and OH-Pak SB 802.5 HQ from Shodex, Japan; eluent: 80% by volume aqueous solution of HCO₂NH₄ (0.05 mol/l) and 20% by volume of acetonitrile; injection volume 100 μl; flow rate 0.5 ml/min). Calibration for determining the average molar mass was carried out using linear poly(ethylene oxide) and polyethylene glycol standards. The measure of the conversion is the peak of the copolymer, standardized to a relative height of 1, and the height of the peak of the unreacted macromonomer/PEG-containing oligomer is used as a measure of the residual monomer content.

The polymeric dispersant preferably meets the requirements of the industrial standard EN 934-2 (February 2002).

The polymeric dispersants comprising the structural units (I) and (II) are prepared in a conventional way, by means of radical polymerization, for example. This is described for example in EP0894811, EP1851256, EP2463314 and EP0753488.

In one embodiment the polymeric dispersant is a polycondensation product which comprises the structural units (III) and (IV):

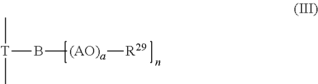

in which
T is a substituted or unsubstituted phenyl radical, substituted or unsubstituted naphthyl radical or a substituted or unsubstituted heteroaromatic radical having 5 to 10 ring atoms, of which 1 or 2 atoms are heteroatoms selected from N, O and S;
n is 1 or 2;
B is N, NH or O, with the proviso that n is 2 if B is N and with the proviso that n is 1 if B is NH or O;
A is CₓH₂ₓ with x=2, 3, 4 or 5, or is CH₂CH(C₆H₅);
a is an integer from 1 to 300; and
R²⁹ is H, a branched or unbranched C₁ to C₁₀ alkyl radical, C₅ to C₈ cycloalkyl radical, aryl radical, or heteroaryl radical having 5 to 10 ring atoms, of which 1 or 2 atoms are heteroatoms selected from N, O and S;
where the structural unit (IV) is selected from the structural units (IVa) and (IVb):

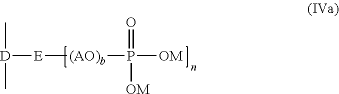

in which
D is a substituted or unsubstituted phenyl radical, substituted or unsubstituted naphthyl radical or a substituted or unsubstituted heteroaromatic radical having 5 to 10 ring atoms, of which 1 or 2 atoms are heteroatoms selected from N, O and S;
E is N, NH or O, with the proviso that n is 2 if E is N and with the proviso that n is 1 if E is NH or O;
A is CₓH₂ₓ with x=2, 3, 4 or 5, or is CH₂CH(C₆H₅);
b is an integer from 1 to 300; and
M independently at each occurrence is H or one cation equivalent;

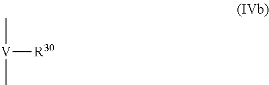

in which
V is a substituted or unsubstituted phenyl radical, substituted or unsubstituted naphthyl radical and is optionally substituted by 1 or two radicals selected independently of one another from R³¹, OH, OR³¹, (CO)R³¹, COOM, COOR³¹, SO₃R³¹ and NO₂;
R³⁰ is COOM, OCH₂COOM, SO₃M or OPO₃M₂;
R³¹ is C₁-C₄ alkyl, phenyl, naphthyl, phenyl-C₁-C₄ alkyl or C₁-C₄ alkylphenyl; and
M independently at each occurrence is H or one cation equivalent.

The structural units T and D in the general formulae (III) and (IVa) in the polycondensation product are preferably derived from phenyl, 2-hydroxyphenyl, 3-hydroxyphenyl, 4-hydroxyphenyl, 2-methoxyphenyl, 3-methoxyphenyl, 4-methoxyphenyl, naphthyl, 2-hydroxynaphthyl, 4-hydroxynaphthyl, 2-methoxynaphthyl, 4-methoxynaphthyl, phenoxyacetic acid, salicylic acid, preferably from phenyl, where T and D may be selected independently of one another and may also each be derived from a mixture of the stated radicals. The groups B and E independently of one another are preferably O. All structural units A may be identical or different not only within individual polyether side chains but also between different polyether side chains. In one particularly preferred embodiment, A is C₂H₄.

In the general formula (III), a is preferably an integer from 3 to 200 and more particularly 5 to 150, and in the general formula (IV) b is preferably an integer from 1 to 300, more particularly 1 to 50 and more preferably 1 to 10. Furthermore, the radicals of the general formulae (III) or (IV) may independently of one another in each case possess the same chain length, in which case a and b are each represented by a number. In general it will be useful for, in each case, mixtures with different chain lengths to be present, so that the radicals of the structural units in the polycondensation product have different numerical values for a and, independently, for b.

The polycondensation product of the invention frequently has a weight-average molecular weight of 5000 g/mol to 200 000 g/mol, preferably 10 000 to 100 000 g/mol and more preferably 15 000 to 55 000 g/mol.

The molar ratio of the structural units (III):(IV) is typically 4:1 to 1:15 and preferably 2:1 to 1:10. It is advantageous to have a relatively high fraction of structural units (IV) in the polycondensation product, since a relatively high negative charge of the polymers has a good influence on the stability of the aqueous preparation. The molar ratio of the structural units (IVa):(IVb), when both are present, is typically 1:10 to 10:1 and preferably 1:3 to 3:1.

In a preferred embodiment of the invention the polycondensation product comprises a further structural unit (V), which is represented by the formula below:

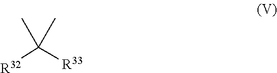

in which
R³² is H, CH₃, COOH or substituted or unsubstituted phenyl or substituted or unsubstituted naphthyl;
R³³ is H, CH₃, COON or substituted or unsubstituted phenyl or substituted or unsubstituted naphthyl.

Preferably R³² and R³³ are H or one of the radicals R³² and R³³ is H and the other is CH₃.

R³² and R³³ in structural unit (V) are typically identical or different and are H, COOH and/or methyl. Very particular preference is given to H.

In another embodiment the molar ratio of the structural units [(III)+(IV)]:(V) in the polycondensate is 2:1 to 1:3.

The polycondensates are typically prepared by a process which comprises reacting with one another the compounds forming the basis for the structural units (III), (IV) and (V). The preparation of the polycondensates is for example described in WO 2006/042709 and WO 2010/026155.

The monomer with a keto group is preferably an aldehyde or ketone. Examples of monomers of the formula (V) are formaldehyde, acetaldehyde, acetone, glyoxylic acid and/or benzaldehyde. Formaldehyde is preferred.

The polymeric dispersant of the invention may also be present in the form of its salts, such as, for example, the sodium, potassium, organic ammonium, ammonium and/or calcium salt, preferably as the sodium and/or calcium salt.

The additives according to the invention preferably contain 50% to 90% water and 10% to 50% solid, more preferably 55%-85% water and 15% to 45% solid. The solid here comprises the polymer and also the sparingly soluble salt of the invention.

The additive of the invention may take the form of an aqueous product in the form of a solution, emulsion or dispersion or in solid form, for example as a powder, after a drying step. The water content of the additive in solid form is in that case preferably less than 10% by weight, more preferably less than 5% by weight. It is also possible for some of the water, preferably up to 10% by weight, to be replaced by organic solvents. Advantageous are alcohols such as ethanol, (iso)propanol and 1-butanol, including its isomers. Acetone can be used as well. By the use of the organic solvents it is possible to influence the solubility and hence the crystallization behavior of the salts of the invention.

The amount of the additive in the composition of the invention may be in particular from 0.01 to 4% by weight, preferably 0.05 to 1.5% by weight and more particularly 0.075 to 1% by weight.

The binder of the composition of the invention based on calcium sulfate is preferably α-hemihydrate, α/β-hemihydrate, β-hemihydrate, natural anhydrite, synthetic anhydrite, anhydrite obtained from flue gas desulfurization, and/or mixtures of two or more thereof. In particular the amount of the binder based on calcium sulfate, based on the total mass of the composition, may be at least 25% by weight, preferably at least 35% by weight, especially preferably at least 50% by weight, and more particularly at least 75% by weight.

In a further embodiment the composition of the invention may comprise at least one further binder from the series of Portland cement, white cement, calcium aluminate cement, calcium sulfoaluminate cement, and pozzolanic binders such as, for example, flyash, metakaolin, silica dust and slag sand. The amount of this further binder may in particular be up to 75% by weight, preferably up to 50% by weight, especially preferably up to 25% by weight, and more particularly up to 15% by weight. In a further embodiment the composition of the invention contains no inorganic binders other than the calcium sulfate-based binder.

The composition of the invention may further comprise at least one compound from the series of silica sand, finely ground quartz, limestone, heavy spar, calcite, aragonite, vaterite, dolomite, talc, kaolin, mica, chalk, titanium dioxide, rutile, anatase, aluminum hydroxide, aluminum oxide, magnesium hydroxide and brucite.

The present invention further provides for a process for producring the composition of the invention, in which
a) the at least one water-soluble salt of a polyvalent metal cation,
b) the at least one compound able to release an anion which forms a sparingly soluble salt with the polyvalent metal cation, and
c) the at least one polymeric dispersant which comprises anionic and/or anionogenic groups and polyether side chains, are contacted with one another in the presence of water, and the resulting additive is contacted
d) with the further components of the composition, comprising the binder based on calcium sulfate.

In one particularly preferred embodiment, the process of the invention comprises a drying step for producing the additive. The drying may be accomplished in particular by roll drying, spray drying, drying in a fluidized-bed process, by bulk drying at elevated temperature, or other customary drying techniques. The preferred range for the drying temperature is between 50 and 230° C.

The additives of the invention are prepared by contacting the at least one water-soluble salt of the polyvalent metal cation and the polymeric dispersant in an aqueous medium, in solid form or in a polymer melt. The at least one water-soluble salt of the metal cation may be provided in solid form, or else, expediently, as an aqueous solution or suspension. It is therefore possible to add the at least one polyvalent metal cation salt in the form of a powder, an aqueous solution or else an aqueous suspension to an aqueous solution of a dispersant.

The at least one compound able to release an anion may likewise be used both in solid form (preparation in situ of a solution, or contacting with the polymer melt) or else preferably in the form of an aqueous solution.

An additive of the invention may be obtained by precipitating the sparingly soluble salt in the presence of the polymeric dispersant, to give a colloidally disperse preparation of the salt. The precipitation of the sparingly soluble salt here means the formation of colloidally disperse salt particles which are dispersed by the polymeric dispersant and their further coagulation is prevented.

Irrespective of whether the salt of the polyvalent metal cation is precipitated in the presence of the polymeric dispersant or whether a freshly precipitated salt of the polyvalent metal cation is dispersed in the presence of the polymeric dispersant, the additive of the invention may also be obtained, alternatively, by additionally admixing the preparation with a pH neutralizer as described above.

An additive of the invention may also be obtained by peptizing a hydroxide and/or oxide of the polyvalent metal cation with an acid, in which case the acid is selected preferably from boric acid, carbonic acid, oxalic acid, silicic acid, polyphosphoric acid, phosphoric acid and/or phosphorous acid.

The additive is prepared generally by mixing the components, which are preferably in the form of an aqueous solution. In this case it is preferred first to mix the polymeric dispersant and the at least one polyvalent metal cation salt and then to add the at least one compound able to release the anion which forms a sparingly soluble salt with the polyvalent metal cation. According to another embodiment, the polymeric dispersant and the at least one compound able to release the anion are mixed first, and then the at least one polyvalent metal cation is added. To adjust the pH it is then possible to add an acid or base. The components are mixed generally at a temperature in the range from 5 to 80° C., usefully 10 to 40° C., and more particularly at room temperature (about 20-30° C.).

An additive of the invention may also be obtained by dispersing a freshly precipitated sparingly soluble salt in the presence of the polymeric dispersant. Freshly precipitated here means immediately subsequent to the precipitation, while the salt is substantially amorphous (no more than 30% by weight, preferably no more than 15% by weight crystallinity); i.e. within about five minutes, preferably within one or two minutes, after the precipitation.

Those solids termed “amorphous” are solids whose atomic building blocks are not arranged in crystal lattices, i.e. do not have a long-range order, but instead only have a more or less pronounced close-range order. While crystalline substances exhibit numerous sharp reflections in the diffraction of x-rays, electron beams and neutron beams, amorphous solids exhibit at most a few diffuse interference rings (halos) at small diffraction angles.

The preparation of the additives may take place continuously or batchwise. The mixing of the components is accomplished in general in a reactor with a mechanical stirring mechanism. The stirring speed of the stirring mechanism may be between 10 rpm and 2000 rpm. An alternative option is to mix the solutions using a rotor-stator mixer, which may have stirring speeds in the range from 1000 to 30 000 rpm. Furthermore, it is also possible to use different mixing geometries, such as a continuous process in which the solutions are mixed using a Y-mixer, for example.

The contacting of the additive with the other components of the composition, comprising the calcium sulfate-based binder, may take place in any way known to the skilled person for this purpose. It has proved particularly appropriate if the liquid additive in the form of a suspension is contacted with the other components of the composition by spray application or jetting application, with the process preferably comprising a mixing step. In this way it is possible to ensure homogeneous distribution in a simple way. The contacting of the additive with the other components of the composition may of course also take place in any other suitable way. Also suitable here, especially in the case of a dried additive of the invention, present preferably in the form of a powder, are blending and stirring in.

The additive of the invention can be used in the composition of the invention as a slump retainer, in which the calcium sulfate-based binder is preferably selected from α-hemihydrate, α/β-hemihydrate, β-hemihydrate, natural anhydrite, synthetic anhydrite, anhydrite obtained from flue gas desulfurization, and/or mixtures of two or more thereof.

The composition of the invention is generally stable on storage. The composition preferably exhibits its long workability even after more than six months. Storage stability is “high” when the parameter “delta after 60 min”, as described in the applications tests, after six-month storage of the additive is at least 70% of the value for the freshly produced additive.

The concept of the slump retainer in this application means that the additives, over a working time of up to 90 minutes, preferably up to 60 minutes, after the mixing of the composition of the invention with water, produce a slump of the binder suspension that is as sufficient as possible for the conditions of the application case in question, is extremely high and in particular does not drop substantially over the aforementioned time period. The additives make it possible to set a profile of properties which is tailored to the respective application.

The compositions of the invention, in addition to the additive of the invention, comprising polymeric plasticizer, polyvalent metal cation and anion of the invention, may also comprise further components. These further components include water-reducing plasticizers such as, for example, lignosulfonate, naphthalenesulfonate condensates, sulfonated melamine resins, or conventional polycarboxylate ethers, and also defoamers, air entrainers, retarders, shrinkage reducers and/or hardening accelerators.

The examples which follow illustrate the advantages of the present invention.

### EXAMPLES

### Gel Permeation Chromatography

The sample preparation for the determination of molar weights took place by dissolving the polymer solution in the GPC buffer, to give a polymer concentration in the GPC buffer of 0.5% by weight. Thereafter this solution was filtered through a syringe filter with polyethersulfone membrane and a pore size of 0.45 μm. The injection volume of this filtrate was 50-100 μl.

The average molecular weights were determined on a GPC instrument from Waters with the model name Alliance 2690, with a UV detector (Waters 2487) and an RI detector (Waters 2410).
Columns: Shodex SB-G Guard Column for SB-800 HQ series
   Shodex OHpak SB 804HQ and 802.5HQ
   (PHM gel, 8×300 mm, pH 4.0 to 7.5)
Eluent: 0.05 M aqueous ammonium formate/methanol mixture=80:20 (parts by volume)
Flow rate: 0.5 ml/min
Temperature: 50° C.
Injection: 50 to 100 μl
Detection: RI and UV

The molecular weights of the polymers were determined with two different calibrations. Determination took place first of all relative to polyethylene glycol standards from the company PSS Polymer Standards Service GmbH. The molecular weight distribution curves of the polyethylene glycol standards were determined by means of light scattering. The masses of the polyethylene glycol standards were 682 000, 164 000, 114 000, 57 100, 40 000, 26 100, 22 100, 12 300, 6240, 3120, 2010, 970, 430, 194, 106 g/mol.

### General Spray Drying Protocol

The additives of the invention can be converted into powder form by spray drying. In that case the aqueous solutions or suspensions of the additives of the invention are dried using a spray dryer (e.g. Mobil Minor from GEA Niro) at an entry temperature of about 230° C. and an exit temperature of about 80° C. For this purpose the aqueous solutions of the additives of the invention were initially admixed with 1% by weight (based on the solids content of the aqueous solution) of a mixture of Additin RC 7135 LD (antioxidant; Rhein Chemie GmbH) and a water-miscible solvent based on polyethylene glycol (Pluriol A 500 E, BASF SE), which is used in the same amount by weight as the aqueous solutions or suspension of the additives of the invention. The resulting powders are admixed with 1% by weight of finely divided silica (N20P, Wacker Chemie AG), ground using a Retsch Grindomix RM 200 mill at 8000 rpm for 10 seconds, and filtered through a 500 μm sieve.

### Polymer Synthesis

The comb polymer P1 is based on the monomers maleic acid, acrylic acid and vinyloxybutylpolyethylene glycol. The synthesis of the comb polymer P1 is described in WO 2010/066470 at page 10 line 1 to line 38.

The comb polymer P2 is based on the monomers acrylic acid and vinyloxybutylpolyethylene glycol. The synthesis of the comb polymer P2 is described in WO 2006/133933 at page 13 line 15 to line 26, the synthesis described having been modified by using 21.7 g of acrylic acid rather than the 26 g of acrylic acid described, and by using 8.3 g of NaOH (20%) rather than the 10 g of NaOH (20%) described.

### Example Calculation of the Charge Density:

$${Σ}_{j} {z}_{S , j} {n}_{s , j} in mmol per gram of polymer = \frac{\begin{matrix}n ( number of moles of initial mass of acid monomers in mmol ) \cdot \\ charge number of acid monomer\end{matrix}}{\begin{matrix}m ( mass of polymer solution in g ) . \\ solids content of the polymer solution in \%\end{matrix}}$$

### Example Calculation for Polymer P2

$${Σ}_{j} {z}_{S , j} {n}_{s , j} = \frac{( 18.6 mmol \cdot 1 )}{( 50 g \cdot 43.1 \% \text{/} 100 )} = 0.86 mmol \text{/} g$$

TABLE 1
Physical data of the comb polymers

| | P1 | P2 |
|---|---|---|
| Σⱼ z_{S,j} × n_{s,j} in mmol per gram of polymer | 0.93 | 0.86 |
| Mw (GPC) | 40 000 | 50 000 |

### Examples of Preparation of the Additives of the Invention

### General Protocol:

The aqueous solution of the comb polymer is mixed with the metal cation salts of the invention, with the anion compounds of the invention, and also, optionally, with a base or acid to adapt the pH, with stirring. Mixing is carried out in a 1 l jacketed glass reactor with paddle stirrer, temperature-conditioned at 20° C., at 300 rpm. The sequence of the addition is indicated in the table by a letter code. P stands for the aqueous solution of the comb polymer, K for the metal cation salt of the invention, A for the anion compound of the invention, and B and S for base and acid, respectively. A code of PKAB, for example, means that the polymer P is introduced initially, then the metal cation salt K is added. Thereafter the anion compound A and the base B are added. The amounts are always based on the solids contents. The final pH of the resulting solutions or suspensions is likewise indicated.

### Example Calculation of Formula (a) on the Basis of Example 1:

The corresponding masses are taken from the table of initial masses: Mass of polymer P1 14.71 g and mass of Ca(OH)₂ 1.46 g.

therefore
n_{K}=1.46 g/74.1 g/mol=19.7 mmol,
n_{S}=14.71 g·0.86 mmol/g=12.65 mmol and

$$\frac{{Σ}_{i} {z}_{K , i} {n}_{K , i}}{{Σ}_{j} {z}_{S , j} {n}_{s , j}} = \frac{19.7 mmol \cdot 2}{12.65 mmol \cdot 1} = 3.12$$

### Examples of Additives of the Invention are Compiled in Tables 2 to 5 Below:

TABLE 2
Composition of the liquid precursors of the examples of the invention

| No. | Poly- mer | Metal salts | Anion comp. | Base/ acid | pH | Sequence | Water (m %) | Polymer (m %) | Metal salt 1 (m %) | Acid (m %) | Anion comp. (m %) | Base (m %) | $\frac{{\sum }_{i} {z}_{K , i} * {n}_{K , i}}{{\sum }_{j} {z}_{S , j} * {n}_{S , j}}$ | $\frac{{\sum }_{l} {z}_{A , l} \times {n}_{A , l}}{{\sum }_{j} {z}_{K , i} \times {n}_{K , i}}$ |
|---|---|---|---|---|---|---|---|---|---|---|---|---|---|---|
| 1 | P2 | Ca(OH)₂ | H₃P | NaO | 10, | PKSAB | 78.24 | 14.71 | 1.46 | 3.68¹ | 0.64 | 1.27 | 3.12 | 0.5 |
| 2 | P1 | Ca(OH)₂ | H₃P | NaO | 9.4 | PKSAB | 76.7 | 16.3 | 1.5 | 3.9¹⁾ | 0.7 | 1.0 | 2.68 | 0.5 |
| 3 | P1 | Ca(OH)₂ | H₃P | NaO | 9.3 | PKSAB | 73.5 | 21.7 | 1.0 | 2.6¹⁾ | 0.4 | 0.8 | 1.34 | 0.5 |
| 4 | P2 | Ca(OH)₂ | H₃P | NaO | 9.5 | PKSAB | 73.9 | 21.0 | 1.0 | 2.5²⁾ | 0.5 | 1.1 | 1.53 | 0.5 |
| 5 | P1 | Ca(NH₂SO | H₃P | NaO | 9.4 | PKAB | 68.5 | 21.8 | 8.5 | — | 0.5 | 0.7 | 1.34 | 0.5 |

¹⁾Amidosulfonic acid;
²⁾Acetic acid

TABLE 3
Pulverulent additives

| No. | Polymer | Metal salts | Anion comp. | Base/ acid | pH | Sequence | Water (m %) | Polymer (m %) | Metal salt 1 (m %) | Acid (m %) | Anion comp. (m %) | Base (m %) | $\frac{{\sum }_{i} {z}_{K , i} * {n}_{K , i}}{{\sum }_{j} {z}_{S , j} * {n}_{S , j}}$ | $\frac{{\sum }_{l} {z}_{A , l} \times {n}_{A , l}}{{\sum }_{j} {z}_{K , i} \times {n}_{K , i}}$ |
|---|---|---|---|---|---|---|---|---|---|---|---|---|---|---|
| 1 | P2 | Ca(OH)₂ | H₃P | NaO | 10, | PKSA | | 67.6 | 6.7 | 16.9¹⁾ | 3.0 | 5.9 | 3.12 | 0.5 |
| 2 | P1 | Ca(OH)₂ | H₃P | NaO | 9.4 | PKSA | | 69.9 | 6.5 | 16.6¹⁾ | 2.9 | 4.1 | 2.68 | 0.5 |
| 3 | P1 | Ca(OH)₂ | H₃P | NaO | 9.3 | PKSA | | 81.9 | 3.8 | 9.7¹⁾ | 1.7 | 2.9 | 1.34 | 0.5 |
| 4 | P2 | Ca(OH)₂ | H₃P | NaO | 9.5 | PKSA | | 80.8 | 4.0 | 9.2²⁾ | 1.8 | 4.2 | 1.53 | 0.5 |
| 5 | P1 | Ca(NH₂SO₃ | H₃P | NaO | 9.4 | PKAB | | 83.4 | 12.1 | — | 1.7 | 2.8 | 1.34 | 0.5 |

The reference mortar is composed of anhydrite and 60% by weight of standard sand (DIN EN 196-1). As initiator, either 0.45% by weight of potassium sulfate or 0.90% by weight of Portland cement was added. The amount of anhydride is selected so as to give 100% by weight. The amount of water, based on the dry mortar, is 14.0% by weight, corresponding to a water-binder ratio of 0.35. For all of the experiments, the plasticizer content was selected such that the mortars attained a Hägermann cone slump of 280±5 mm 5 minutes after addition of water.

The mortars are produced in accordance with DIN EN 196-1:2005 in a mortar mixer with a capacity of 5 l. For mixing up, water, plasticizer and anhydrite are introduced into the mixing vessel. Immediately thereafter the mixing operation is commenced, with the fluidizer at a low speed (140 rpm). After 30 seconds, the sand is added at a uniform rate over the course of 30 seconds (s) to the mixture. Thereafter the mixer is switched over to a higher speed (285 rpm) and mixing is continued for a further 30 s. The mixer is subsequently stopped for 90 s. During the first 30 s, the mortar sticking to the wall and to the lower part of the bowl is removed with a rubber scraper and put into the middle of the bowl. After the pause, the mortar is mixed for a further 60 s at the higher mixing speed. The total mixing time is 4 min.

Immediately after the end of the mixing operation, the slump of all the mortars is determined with the Hägermann cone, without any compaction energy being supplied, in accordance with the SVB Guidelines of the Deutscher Ausschuss fur Stahlbeton [German Reinforced Concrete Committee] [1]. The Hägermann cone (dtop=70 mm, p or 5 minutes after first contact between cement and water, the Hägermann cone is taken off, held over the slumping mortar for 30 seconds to allow for dripping, and then removed. As soon as the slump flow comes to a standstill, the diameter is determined, using a calliper gage, at two axes lying at right angles to one another, and the average is calculated. After the measurement, the sample is disposed of. At ages of 9, 29 and 59 minutes, the mortar which has remained in the mixing vessel is mixed up again with the mortar mixer for 10 s, in order to break down the resting structure, and this mortar is introduced into the Hägermann cone, and the slump is determined.
[1] Deutscher Ausschuss für Stahlbetonbau (Ed.): DAfStb—Richtlinie Selbstverdichtender Beton [Self-compacting concrete guideline] (SVB Guideline). Berlin, 2003

### Performance Examples

### 1) Self-Leveling Screed Based on Synthetic Anhydrite

### Mixed Design:

39.55% by weight synthetic anhydrite (Lanxess Anhydrittbinder CAB 30 (SO1281731), Stulln works)
0.45% by weight K₂SO₄
60.00% by weight standard sand
w/b=0.35
Target slump after 5 minutes: 28±1 cm

TABLE 4
Slump of self-leveling screed based on synthetic anhydrite

| | | | | | | | | Delta |
|---|---|---|---|---|---|---|---|---|
| | | Metering | Time of measurement | | | | | 120 − 5 min |
| Polymer | Form | [%] | 5 min | 10 min | 30 min | 60 min | 120 min | [cm] |
| Melment | Powder | 0.35 | 27.5 | 27.1 | 25.7 | 24.5 | 23.2 | −4.3 |
| F10 | | | | | | | | |
| P1 | Solution | 0.07 | 28.4 | 27.8 | 25.7 | 23.8 | 22.4 | −6.0 |
| P2 | Powder | 0.055 | 28.9 | 28.3 | 26.1 | 23.5 | 21.6 | −7.3 |
| 1 | Powder | 0.14 | 29.0 | 30.4 | 30.4 | 30.2 | 29.3 | +0.3 |
| 2 | Powder | 0.26 | 27.7 | 30.2 | 30.5 | 30.2 | 30.3 | +2.6 |
| 3 | Powder | 0.165 | 28.0 | 29.8 | 30.5 | 30.1 | 30.3 | +2.3 |
| 4 | Powder | 0.08 | 28.0 | 28.7 | 27.6 | 27.7 | 27.4 | −0.6 |

### 2) Self-Leveling Screed Based on Natural Anhydrite

### Mixed Design:

39.10% by weight natural anhydrite (Knauf NAH Staub, Heidenheim works)
0.90% by weight OEM I 52.5 N (Milke)
60.00% by weight standard sand
w/b=0.35
Target slump after 5 minutes: 28±1 cm

TABLE 5
Slump of self-leveling screed based on natural anhydrite

| | | Metering | | | | | | |
|---|---|---|---|---|---|---|---|---|
| | | [% by wt. | | | | | | Delta |
| | | based on | Slump in cm after | | | | | (120 − 5 min) |
| Polymer | Form | binder] | 5 min | 10 min | 30 min | 60 min | 120 min | [cm] |
| P1 | Solution | 0.09 | 27.6 | 26.9 | 25.9 | 22.0 | 14.6 | −13.0 |
| 5 | Powder | 0.14 | 28.1 | 29.2 | 29.6 | 29.8 | 29.1 | +1.0 |

1. A composition comprising, based on the total mass of the composition:
A) at least 10 wt % of a binder based on calcium sulfate and
B) 0.005 to 5 wt % of an additive prepared from components comprising:
i) at least one water-soluble salt of a polyvalent metal cation,
ii) at least one compound able to release an anion which forms a sparingly soluble salt with the polyvalent metal cation, and
iii) at least one polymeric dispersant which comprises an anionic and/or anionogenic group, and a polyether side chain,
wherein the polyvalent metal cation being is at least one selected from the group consisting of Al³⁺, Fe³⁺, Fe²⁺, Cu²⁺, Mg²⁺, Ca²⁺, Sr²⁺, Ba²⁺ and mixtures thereof,
the metal cation is present in an amount such that the relation according to formula (a) is greater than 0.1 and less than or equal to 30:
$$0.1 < \frac{{Σ}_{i} {z}_{K , i} {n}_{K , i}}{{Σ}_{j} {z}_{s , j} {n}_{s , j}} \leq 30. \qquad ( a )$$
z_{K,i} is the amount of the charge number of the polyvalent metal cation,
n_{K,i} is the number of moles of the polyvalent metal cation,
z_{S,j} is the amount of the charge number of the anionic and/or anionogenic group present in the polymeric dispersant,
n_{S,j} is the number of moles of the anionic and/or anionogenic group present in the polymeric dispersant,
the indices i and j are independent of one another and are each an integer greater than 0,
i is the number of different polyvalent metal cations, and
j is the number of different anionic and/or anionogenic groups present in the polymeric dispersant.

2. The composition according to claim 1, wherein the polyvalent metal cation and the anion being are present in amounts satisfying the formulae:
$$\begin{matrix}0.1 < \frac{{Σ}_{i} {z}_{K , i} {n}_{K , i}}{{Σ}_{j} {z}_{s , j} {n}_{s , j}} \leq 30 & ( a ) \\ 0.01 < \frac{{Σ}_{l} {z}_{A , l} {n}_{A , l}}{{Σ}_{j} {z}_{K , i} {n}_{K , i}} \leq 3 , & ( b )\end{matrix}$$
z_{K,i} is the amount of the charge number of the polyvalent metal cation,
n_{K,i} is the number of moles of the polyvalent metal cation,
z_{S,j} is the charge number of the anionic and/or anionogenic group present in the polymeric dispersant,
n_{S,j} is the number of moles of the anionic and/or anionogenic group present in the polymeric dispersant,
z_{A,l} is the charge number of the anion,
n_{A,l} is the number of moles of the anion,
the indices i, j and l are independent of one another and are each an integer greater than 0,
i is the number of different polyvalent metal cations,
j is the number of different anionic and/or anionogenic groups present in the polymeric dispersant, and
l is the number of different anions which are able to form a sparingly soluble salt with the metal cation.

3. The composition according to claim 1, wherein the anion is at least one selected from the group consisting of carbonate, oxalate, silicate, phosphate, polyphosphate, phosphite, borate, aluminate, ferrate, zincate and sulfate.

4. The composition according to claim 2, wherein the polyvalent metal cation and the anion are present in the additive in amounts satisfying the formula:
$$0.25 < \frac{{( {Σ}_{i} {z}_{K , i} {n}_{K , i} )}^{2}}{( {Σ}_{l} {z}_{A , l} {n}_{A , l} ) ( {Σ}_{j} {z}_{s , j} {n}_{s , j} )} < 25. \qquad ( c )$$

5. The composition according to claim 1, wherein the additive further comprises at least one pH neutralizer.

6. The composition according to claim 5, wherein the pH neutralizer is at least one selected from the group consisting of alkali metal hydroxide, organic monoamine, organic diamine, organic polyamine and ammonia.

7. The composition according to claim 1, the polymeric dispersant comprising as the anionic and/or anionogenic group at least one structural unit of the general formula (Ia), (Ib), (Ic) and/or (Id): 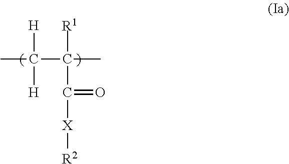
R¹ is H or an unbranched or branched C₁-C₄ alkyl group, CH₂COOH or CH₂CO—X—R²;
for X and R², either
X is NR³—(CₙH₂ₙ) or O(CₙH₂ₙ) with n=1, 2, 3 or 4, the nitrogen atom or the oxygen atom, respectively, being attached to the CO group, and
R² is PO₃M₂, O—PO₃M₂, (C₆H₄)—PO₃M₂ or (C₆H₄)—OPO₃M₂,
Or
X is a chemical bond and R² is OM;
R³ is H, C₁-C₆ alkyl, (CₙH₂ₙ)—OH, (CₙH₂ₙ)—PO₃M₂, (CₙH₂ₙ)—OPO₃M₂, (C₆H₄)—PO₃M₂, (C₆H₄)—OPO₃M₂ or (CₙH₂ₙ)—O-(AO)α-R⁴;
α is an integer from 1 to 350;
R⁴ is H or an unbranched or branched C₁-C₄ alkyl group; and
M independently at each occurrence is H or one cation equivalent; 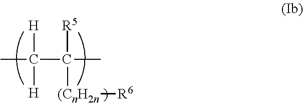
R⁵ is H or an unbranched or branched C₁-C₄ alkyl group;
n is 0, 1, 2, 3 or 4;
R⁶ is PO₃M₂ or O—PO₃M₂; and
M independently at each occurrence is H or one cation equivalent; 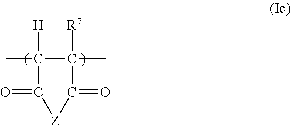
R⁷ is H or an unbranched or branched C₁-C₄ alkyl group;
Z is O or NR⁸; and
R⁸ is Hₛ (CₙH₂ₙ)—OH, (CₙH₂ₙ)—PO₃M₂, (CₙH₂ₙ)—OPO₃M₂, (C₆H₄)—PO₃M₂, or (C₆H₄)—OPO₃M₂;
n is 1, 2, 3 or 4, and
M independently at each occurrence is H or one cation equivalent; 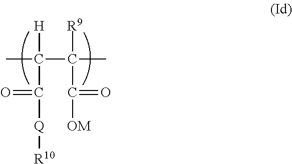
R⁹ is H or an unbranched or branched C₁-C₄ alkyl group;
Q is NR¹⁰ or O;
R¹⁰ is H, (CₙH₂ₙ)—OH, (CₙH₂ₙ)—PO₃M₂, (CₙH₂ₙ)—OPO₃M₂, (C₆H₄)—PO₃M₂, (C₆H₄)—OPO₃M₂ or (CₙH₂ₙ)—O-(AO)_{β}—R¹¹;
A is CₓH₂ₓ with x=2, 3, 4 or 5 or is CH₂CH(C₆H₅);
β is an integer from 1 to 350;
R¹¹ is H or an unbranched or branched C₁-C₄ alkyl group;
n is 1, 2, 3 or 4; and
M independently at each occurrence is H or one cation equivalent.

8. The composition according to claim 1, the polymeric dispersant comprising as polyether side chain at least one structural unit of the general formulae (IIa), (IIb), (IIc) and/or (IId): 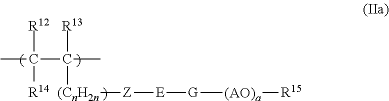
R¹², R¹³ and R¹⁴ independently of one another are each H or an unbranched or branched C₁-C₄ alkyl group;
for E and G, either
E is an unbranched or branched C₁-C₆ alkylene group, a cyclohexylene group, CH₂—C₆H₁₀, 1,2-phenylene, 1,3-phenylene or 1,4-phenylene, and
G is O, NH or CO—NH,
or
E and G together are a chemical bond;
A is CₓH₂ₓ with x=2, 3, 4 or 5 or is CH₂CH(C₆H₅);
n is 0, 1, 2, 3, 4 and/or 5;
a is an integer from 2 to 350;
R¹⁵ is H, an unbranched or branched C₁-C₄ alkyl group, CO—NH₂ and/or COCH₃; 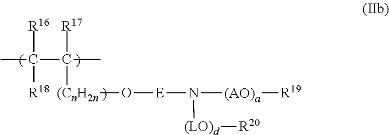
R¹⁶, R¹⁷ and R¹⁸ independently of one another are each H or an unbranched or branched C₁-C₄ alkyl group;
E is an unbranched or branched C₁-C₆ alkylene group, a cyclohexylene group, CH₂—C₆H₁₀, 1,2-phenylene, 1,3-phenylene or 1,4-phenylene or is a chemical bond;
A is CₓH₂ₓ with x=2, 3, 4 or 5 or is CH₂CH(C₆H₅);
L is CₓH₂ₓ with x=2, 3, 4 or 5 or is CH₂—CH(C₆H₅);
a is an integer from 2 to 350;
d is an integer from 1 to 350;
R¹⁹ is H or an unbranched or branched C₁-C₄ alkyl group;
R²⁰ is H or an unbranched C₁-C₄ alkyl group; and
n is 0, 1, 2, 3, 4 or 5; 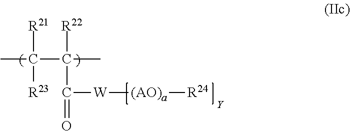
R²¹, R²² and R²³ independently of one another are each H or an unbranched or branched C₁-C₄ alkyl group;
W is O, NR²⁵ or N
Y is 1 if W is O or NR²⁵,
Y is 2 if W is N;
A is CₓH₂ₓ with x=2, 3, 4 or 5 or is CH₂CH(C₆H₅);
a is an integer from 2 to 350;
R²⁴ is H or an unbranched or branched C₁-C₄ alkyl group; and
R²⁵ is H or an unbranched or branched C₁-C₄ alkyl group; 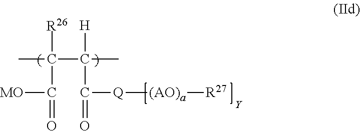
R²⁶ is H or an unbranched or branched C₁-C₄ alkyl group;
Q is NR¹⁰, N or O;
Y is 1 if Q is O or NR²⁸,
Y is 2 if Q is N;
R²⁷ is H or an unbranched or branched C₁-C₄ alkyl group;
R²⁸ is H or an unbranched or branched C₁-C₄ alkyl group;
A is CₓH₂ₓ with x=2, 3, 4 or 5, or CH₂C(C₆H₅)H;
a is an integer from 2 to 350; and
M independently at each occurrence is H or one cation equivalent.

9. The composition according to claim 1, wherein the polymeric dispersant is a polycondensation product comprising structural units (III) and (IV): 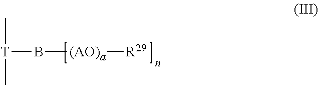
T is a substituted or unsubstituted phenyl or naphthyl radical or a substituted or unsubstituted hetero aromatic radical having 5 to 10 ring atoms, of which 1 or 2 atoms are heteroatoms selected from the group consisting of N, O and S;
n is 1 or 2;
B is N, NH or O, with the proviso that n is 2 if B is N and with the proviso that n is 1 if B is NH or O;
A is CₓH₂ₓ with x=2, 3, 4 or 5 or is CH₂CH(C₆H₅);
a is an integer from 1 to 300; and
R²⁹ is H, a branched or unbranched C₁ to C₁₀ alkyl radical, C₅ to C₈ cycloalkyl radical, aryl radical, or heteroaryl radical having 5 to 10 ring atoms, of which 1 or 2 atoms are heteroatoms selected from the group consisting of N, O and S;
the structural unit (IV) is at least one selected from the group consisting of structural units (IVa) and (IVb): 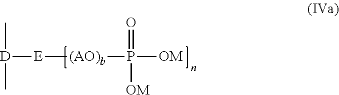
D is a substituted or unsubstituted phenyl or naphthyl radical or a substituted or unsubstituted heteroaromatic radical having 5 to 10 ring atoms, of which 1 or 2 atoms are heteroatoms selected from the group consisting of N, O and S;
E is N, NH or O, with the proviso that n is 2 if E is N and with the proviso that n is 1 if E is NH or O;
A is CₓH₂ₓ with x=2, 3, 4 or 5 or is CH₂CH(C₆H₅);
b is an integer from 1 to 300; and
M independently at each occurrence is H or one cation equivalent; 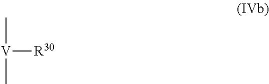
V is a substituted or unsubstituted phenyl or naphthyl radical and is optionally substituted by 1 or two radicals selected from R³¹, OH, OR³¹, (CO)R³¹, COOM, COOR³¹, SO₃R³¹ and NO₂;
R³⁰ is COOM, OCH₂COOM, SO₃M or OPO₃M₂;
R³¹ is C₁-C₄ alkyl, phenyl, naphthyl, phenyl-C₁-C₄ alkyl or C₁-C₄ alkylphenyl; and
M independently at each occurrence is H or one cation equivalent.

10. The composition according to claim 1, characterized in that wherein the binder based on calcium sulfate is α-hemihydrate, α/β-hemihydrate, β-hemihydrate, natural anhydrite, synthetic anhydrite, anhydrite obtained from flue gas desulfurization, and/or mixtures of two or more thereof.

11. The composition according to claim 1, comprising at least one further binder selected from the group consisting of Portland cement, white cement, calcium aluminate cement, calcium sulfoaluminate cement, and pozzolanic binders such as flyash, metakaolin, silica dust and slag sand.

12. The composition according to claim 1, comprising at least one compound selected from the group consisting of silica sand, finely ground quartz, limestone, heavy spar, calcite, aragonite, vaterite, dolomite, talc, kaolin, mica, chalk, titanium dioxide, rutile, anatase, aluminum hydroxide, aluminum oxide, magnesium hydroxide and brucite.

13. A process for preparing the composition according to claim 1, the process comprising:
contacting:
a) the at least one water-soluble salt of a polyvalent metal cation,
b) the at least one compound able to release an anion which forms a sparingly soluble salt with the polyvalent metal cation, and
c) the at least one polymeric dispersant which comprises an anionic and/or anionogenic group and a polyether side chain,
with one another in the presence of water, thereby obtaining an additive, and
contacting the resulting additive with further components of the composition, comprising the binder based on calcium sulfate.

14. The composition according to claim 1, wherein the composition is self-leveling calcium sulfate screed, flowable calcium sulfate filling compound, or calcium sulfate screed of damp-soil consistency.
